(19) United States
(12) Patent Application Publication
(10) Pub. No.: US 2005/0179944 A1
(43) Pub. Date: Aug. 18, 2005

(54) Printing device

(75) Inventors: Kazuhito Gassho, Nagano-ken (JP); Noriyuki Nagai, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/948,655

(22) Filed: Sep. 24, 2004

(30) Foreign Application Priority Data
Sep. 29, 2003 (JP) 2003-337173

(51) Int. Cl. G06F 15/00

(52) U.S. Cl. 358/1.16

(57) ABSTRACT

Each instruction module such as a terminal device 300 causes a printer 100 connected with them via a network to perform printing. Each instruction module uses its reservation unit 313 to send setting data representing the content of setting for printing conditions, and its address, which are then stored in a queue 212 of the printer 100. The printer 100 sets each setting data according to the order in which the setting data are stored in the queue 212, and then informs the instruction module about the completion of setting. In response to the setting completion notification, each instruction mean causes the printer 100 to perform the printing. This ensures equitable chance of printing among the users of the respective instruction module, and avoids conflict among the setting operations.

### BACKGROUND OF THE INVENTION

1. Field of the Invention

The present invention relates to a method of setting a printing condition for a printer, and specifically relates to a technique for avoiding conflict among a plurality of setting instructions.

2. Description of the Related Art

In recent years, cases are coming into widespread use in which a printer is connected to a network, and is shared by a plurality of computers (hereinafter referred to as terminal devices) connected to the network. Each terminal device sets printing conditions such as printing density and printing quality for the printer through the network. Such setting enables each terminal device to cause the printer to perform the printing under desired printing conditions. Alternatively, the setting of printing conditions may be performed through a setting panel provided for the printer. When the printer is shared by a plurality of terminal devices, conflict may occur among the terminal devices and setting panel, that is, conflicting instructions may be given simultaneously. If the conflict occurs, an unexpected value may be set to a parameter of printing condition, or the setting of value may result in failure.

In order to solve such problems, a technique has been proposed where if a certain terminal device is on the setting operation, the printer rejects setting request from another terminal device. In such a technique, the printer updates the state of setting operation in response to the acceptance of setting request to reject another setting request after the update. The user causes the terminal device to request the setting, and then is permitted to set the printing conditions and to print under the setting.

Conventionally, if a certain user is using the printer, another user must wait for the completion of print processing being performed. If a plurality of users desire to use the printer, a user who requests print processing at the timing the previous printing has been completed can subsequently use the printer. Therefore, it is not necessarily possible to use in the waiting order even if waiting for the completion of print processing. Thus, the conventional technique resolves the problem of conflict, but has difficulty in providing each user with equitable chance of using the printer.

### SUMMARY OF THE INVENTION

One object of the present invention is to provide each user with equitable chance of using a printer, and avoiding conflict among setting operations of printing condition.

In order to solve at least part of the above problems, a first aspect of the present invention provides a printer a printer that prints according to an instruction on setting of printing condition, the instruction being sent from instruction module. The printer according to the first aspect includes: a reservation reception unit that receives identification information identifying the instruction module as a reservation for usage of the printer; a storage unit that stores therein the received identification information; a setting unit that acquires setting data and sets a printing condition for the printer according to the setting data, the setting data representing the content of setting given by the instruction module identified by the stored identification information; and a printing unit that prints under the set printing condition.

In the printer of the present invention, a reservation is required to be made by sending the identification information prior to the setting. Therefore, using the identification information enables the timing of receiving the setting to be controlled, and thereby avoiding conflict among a plurality of setting module. In addition, the user is assured of using the printer through the reservation, and thereby increasing equity among the users who share the printer.

The instruction module may include a computer connected with the printer locally or via a network, and a setting panel provided for the printer. The instruction module may give instructions of printing as well as setting the printing conditions. The identification information may include an address of the instruction module, and a user ID of the user of the instruction module.

In the printer according to the first aspect of the present invention, the reservation reception unit may control the reception so that the number of the received identification information for which the acquisition of setting data is not completed is not greater than a predetermined number.

This arrangement enables the number of instruction module (hereinafter referred to as reservation count) whose setting is not completed to be kept not greater than the predetermined number, and thereby reducing the possibility of conflict among the setting operations. The control of reservation count may be achieved by a variety of methods. For example, the control may be based on a difference between the number of identification information for which the reservation has been received and the number of identification information for which the setting has been completed. The reservation count may be the number of identification information remaining in the storage unit after the deletion of the identification information for which the setting has been completed. In such a case, the control may be based on remaining capacity of the storage unit. If the storage unit is configured as a queue, a pointer corresponding to the last identification information may be used for the control.

In the printer according to the first aspect of the present invention, a predetermined validity period may be set for the identification information, and the printer may further includes an invalidating unit that deletes the identification information stored in the storage unit on expiration of the validity period.

This arrangement invalidates a useless reservation for which the setting has not been performed for a long time by the instruction module sent the identification information, and thereby improving equity among the users who share the printer.

In the printer according to the first aspect of the present invention, the storage unit may store therein the identification information in association with a predetermined order of processing, and the setting unit may acquire the setting data according to the order of processing.

This arrangement avoids inequity among the users such as the user who made a reservation earlier is forced to wait unfairly. In this aspect, an order of receiving reservations may be used as the predetermined order of processing. Alternatively, priorities of usage of the printer that are set among the users may be taken into consideration for the order or processing. If the size of print data is known at the time of reservation, the size of print data may be taken into consideration for the order.

In the printer according to the first aspect of the present invention, the reservation reception unit may receive the setting data along with the identification information, the storage unit may store therein the setting data in association with the identification information, and the setting unit may acquire the setting data from the storage unit.

This arrangement enables the user to perform the setting without any additional operation after making the reservation for the usage of the printer since the setting data is acquired along with the identification information, and thereby improving convenience.

The printer according to the first aspect of the present invention may include an information unit that sends permission information indicating a permission of setting and printing to the instruction module having the permission.

The information on the permission of printing enables the user who made the reservation to perform the printing quickly, and thereby improving convenience. In addition, this reduces useless waiting time imposed on the printer, and thereby improving the operating rate of the printer.

A second aspect of the present invention provides a printer a printer that prints according to an instruction on setting of printing condition, the instruction being sent from instruction module. The printer according to the second aspect of the present invention includes: an issue unit that sends predetermined authorization data necessary for reception of the instruction to the instruction module; a setting unit that, only if receiving both setting data representing the content of the setting and the authorization data from the instruction module, performs the setting based on the acquired setting data; and a printing unit that prints under the set printing condition.

Since the authorization data is required for the setting of the printer, the printer may control the number of instruction module that instruct the printer on the setting, and thereby reducing conflict among the instruction module. In addition, the printer uses the authorization data to regulate the number of instruction module that may access the printer, and thereby ensuring chance of using the printer for each user in comparison to the case of the printer being indefinitely accessible to all the users.

The authorization data may be a variety of data distinguishable with respect to one another. A method such as so-called electronic signature may determine whether or not the authorization data has been falsified. This prevents an unauthorized setting.

Each instruction module may acquire the authorization data acquired by another instruction module, and then send it to the printer. The authorization data may include data for identifying the instruction module that may use the authorization data to set the printing conditions. Only if the instruction module that sent the authorization data is identical to the instruction module identified by the authorization data, the printer may accept the setting from the instruction module.

In the printer according to the second aspect of the present invention, the issue unit may control the sending of authorization data so that the number of the sent authorization data for which the setting is unprocessed is not greater than a predetermined number. This arrangement reduces the possibility of conflict among the setting operations.

In the printer according to the second aspect of the present invention, a predetermined validity period may be set for the authorization data, and the setting unit may perform the setting only if receiving the authorization data that is not past the validity period.

This arrangement invalidates a useless authorization data for which the setting has not been performed for a long time, and thereby improving equity among the users who share the printer.

In the printer according to the second aspect of the present invention, the authorization data may be associated with a predetermined order of processing, and the setting unit may determine based on the order of processing whether or not the setting is permitted.

This arrangement avoids inequity among the users such as the user who made a reservation earlier is forced to wait unfairly. In this aspect, an order of issuing authorization data may be used as the predetermined order of processing.

In the case of taking into consideration the order of processing, the printer according to the second aspect of the present invention may further include an information unit that specifies the authorization data to be processed subsequently, and informs the instruction module that the setting is permitted.

This arrangement enables the user to perform the setting quickly by receiving the information, and thereby improving convenience.

In the printer including the information unit and according to the second aspect of the present invention, the setting unit may invalidate the authorization data at the time a predetermined period has elapsed after the information.

This arrangement avoids delay in the setting. In addition, this arrangement invalidates a useless reservation for which the setting has not been performed for a long time by the instruction module having the authorization data to be processed next, and thereby improving equity among the users who share the printer.

A third aspect of the present invention provides a setting device. The setting device according to the third aspect of the present invention, which sets a printing condition for the printer according to the first aspect of the present invention, includes: a reservation unit that sends the identification information to the printer to make the reservation; and a sending unit that generates setting data representing the content of the setting according to an operation of a user, and sends the setting data to the printer.

A fourth aspect of the present invention provides a setting device. The setting device according to the fourth aspect of the present invention, which sets a printing condition for the printer according to the second aspect of the present invention, includes: an acquisition unit that acquires the authorization data from the printer; and a sending unit that generates setting data representing the content of the setting according to an operation of a user, and sends the setting data and the authorization data to the printer.

The present invention may be also embodied in a variety of aspects such as printing method and setting method as well as printer and setting device. In addition, the present invention may be configured as a computer program that causes a computer to implement these methods, or a signal equivalent to the program. Furthermore, the present invention may be configured as a recording medium that stores therein such a computer program.

Such a recording medium may include a variety of computer-readable media such as flexible disk, CD-ROM, magneto-optics disc, IC card, ROM cartridge, punched card, a print with barcodes or other codes printed thereon, internal storage device (memory such as RAM and ROM) and external storage device of the computer, and the like.

### BRIEF DESCRIPTION OF THE DRAWINGS

FIG. 1 is a schematic diagram illustrating a printing system 1000.

FIG. 2 is a schematic diagram illustrating the configuration of function blocks implemented in a terminal device 300 and a printer 100.

FIG. 3 is a flowchart of reservation processing.

FIG. 4 is a flowchart of print processing.

FIG. 5 is a schematic diagram illustrating an example of reservation and print processing in the printing system 1000.

FIG. 6 is a schematic diagram illustrating the configuration of function blocks implemented in each device according to a second embodiment.

FIG. 7 is a flowchart of reservation processing according to the second embodiment.

FIG. 8 is a flowchart of print processing according to the second embodiment.

FIG. 9 is a schematic diagram illustrating an example of reservation and print processing according to the second embodiment.

FIG. 10 is a schematic diagram illustrating the configuration of function blocks implemented in each device according to a third embodiment.

FIG. 11 is a flowchart of reservation processing according to the third embodiment.

FIG. 12 is a flowchart of print processing according to the third embodiment.

FIG. 13 is a schematic diagram illustrating an example of reservation and print processing according to the third embodiment.

FIG. 14 is a schematic diagram illustrating an example of processing in the case where time limit is set for print request.

FIG. 15 is a schematic diagram illustrating the configuration of function blocks implemented in each device in a printing system taking into consideration reservation count.

FIG. 16 is a schematic diagram illustrating an example of reservation and print processing in the printing system taking into consideration the reservation count.

### DESCRIPTION OF THE PREFERRED EMBODIMENTS

Modes of the present invention are described through embodiments in the following sequence.

A. First Embodiment

A1. System Configuration

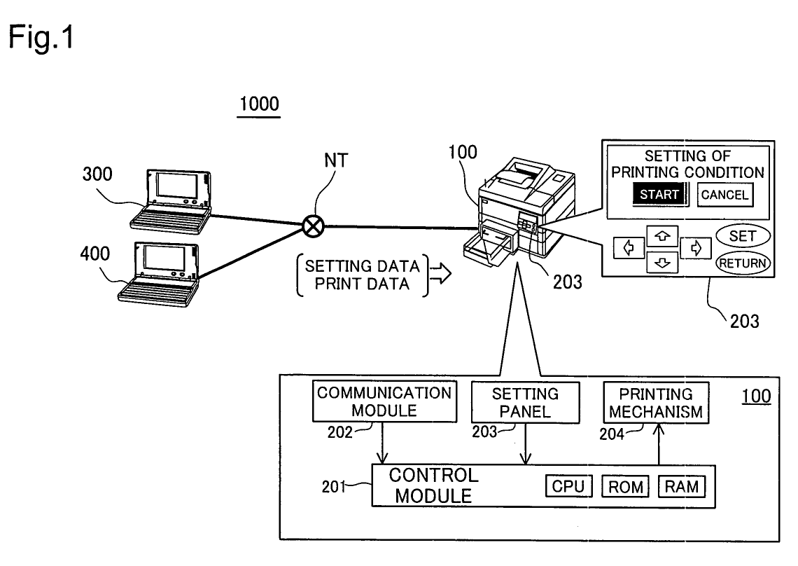

FIG. 1 is a schematic diagram illustrating a printing system 1000. The printing system 1000 includes a printer 100, and terminal devices 300 and 400 connected with the printer 100 via a network NT. The terminal devices 300 and 400 are general-purpose computers. The terminal devices 300 and 400 send setting data representing settings of printing conditions via the network NT to the printer 100 to set the printing conditions such as size of print sheet and printing color for the printer 100. In addition, the terminal devices 300 and 400 send print data representing print contents desired by the respective users to print by using the printer 100. The printer 100 prints according to the set printing conditions. FIG. 1 shows the two terminal devices 300 and 400 for purposes of illustration.

The following description is made for only the terminal device 300, but the terminal device 400 also has the same functions and performs the same processing as the terminal device 300. The network NT may be a limited network such as local area network or an unlimited network such as Internet.

The lower portion of FIG. 1 shows the configuration of the printer 100. A communication module 202 provides communication via the network NT. A printing mechanism 204 prints on the print sheet. A setting panel 203 is a liquid crystal display panel that provides a user interface for setting operations of the printer 100. The user also sets the printing conditions for the printer 100 by operating the setting panel 203 as well as the terminal devices 300 and 400. The following description is made with taking as an example the case where the printing conditions are set through the terminal device 300, but the setting may be performed through the setting panel 203 as well. A control module 201 includes a CPU, ROM, RAM, and other constituents, and controls operations of the other constituents of the printer 100.

A2. Functional Blocks

A2a. Instruction Module

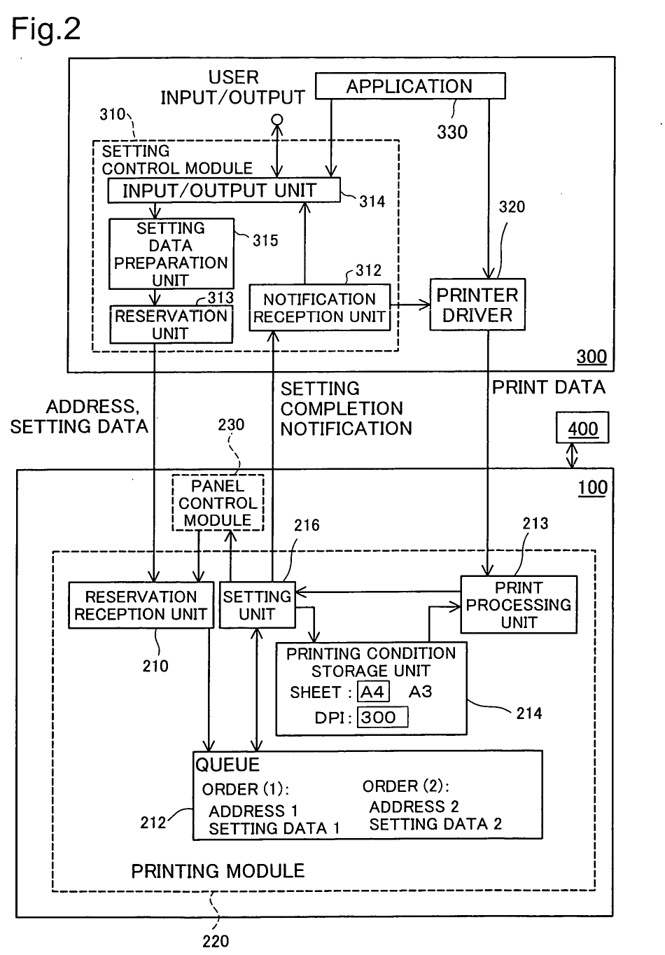

FIG. 2 is a schematic diagram illustrating the configuration of function blocks implemented in the terminal device 300 and the printer 100. Each function block shown in the upper portion of FIG. 2 is implemented by software that is executed by the terminal device 300 on an operating system. Each functional block shown in the lower portion of FIG. 2 is implemented by software as the function of the control module 201 in the printer 100. However, all or part of the functional blocks shown in the upper and lower portions of FIG. 2 may be configured as hardware in the terminal device 300 or in the printer 100.

In the terminal device 300, a printer driver 320 converts document data or image data created by an application 330 into print data that may be handled by the printer 100, and then sends the print data to the printer 100. In addition, the printer driver 320 uses a setting control module 310 to set the printing conditions for the printer 100. The setting control module 310 is a part of the printer driver 320, but they are shown separately for convenience of explanation in this embodiment. Therefore, without a specific explanation, the printer driver 320 represents a module that achieves narrowly-defined functions of generating print data and then sending the print data to the printer 100.

An input/output unit 314 of the setting control module 310 provides an input/output interface for the user of the terminal device 300, and enables information to be transferred between the setting control module 310 and the application 330. A setting data preparation unit 315 prepares setting data representing settings of printing conditions according to the user's input. The setting data may specify some printing conditions such as “using A4 size print sheet”, or may specify all of the printing conditions in a comprehensive manner. The setting data may specify a shift value from the current setting such as “increasing the DPI (dot per inch) by 10.” A reservation unit 313 sends an IP address of the terminal device 300 and the setting data to the printer 100 to reserve the printing.

An information reception unit 312 acquires setting completion notification, which indicates that the printing conditions have been set, from the printer 100, and then transfers this information to the application 330 via the input/output unit 314. In response to the setting completion notification, the application 330 sends the print data to the printer 100 via the printer driver 320. A2b. Printer

The printer 100 includes a panel control module 230 and printing module 220. In response to the instruction from the terminal device 300, the printing module 220 sets the printing conditions, and then uses the print data sent from the terminal device 300 to perform the printing under the set printing conditions. More specifically, a printing condition storage unit 214 stores therein the printing conditions sent from the terminal device 300. A print processing unit 213 acquires the print data sent by the printer driver 320 of the terminal device 300, and then uses the acquired print data, and the printing conditions stored in the printing condition storage unit 214 to perform the printing.

A reservation reception unit 210 acquires the setting data and the address of the terminal device 300 from the terminal device 300 to receive the reservation of the printing. A queue 212 stores therein such setting data and addresses in the order of acquisition. A setting unit 216 sets the printing conditions based on the setting data stored at the top of the queue 212. After setting the printing conditions, the setting unit 216 uses the address corresponding to the setting data to inform the terminal device 300 about the completion of the setting. After the completion of the printing requested by the terminal device 300, the setting unit 216 deletes the address and setting data of the terminal device 300 stored at the top of the queue 212.

The panel control module 230 has the same functions as the setting control module 310 of the terminal device 300. In this embodiment, an address of the printer 100 is also used as an address of the panel control module 230. In addition, if the panel control module 230 receives the setting completion notification from the printing module 220, then it informs the operator of the setting panel 203 about the completion of the setting. Once the operator completes the print processing after the reception of the information, the setting unit 216 deletes the data stored at the top of the queue 212. In this embodiment, the combination of the panel control module 230 and setting panel 203 corresponds to instruction module for setting of the printer 100. The following description is made with taking as an example the case of the setting control module 310, but essentially the similar description is also applicable to the case of the panel control module 230.

A2. Processing

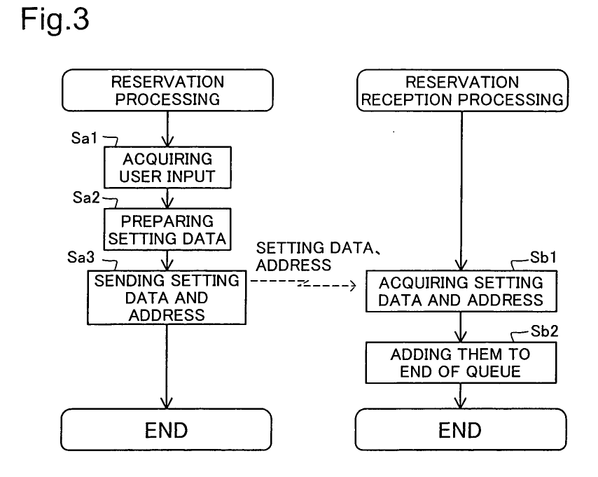

FIG. 3 is a flowchart of reservation processing. The left portion of FIG. 3 shows the processing performed by the terminal device 300, and the right portion shows the processing performed by the printer 100. The user inputs a command for executing the printing to the terminal device 300 to activate the setting control module 310, and thereby initiating the reservation processing. At step Sa1, the terminal device 300 inputs settings of printing conditions according to the user's operation. At step Sa2, the terminal device 300 prepares setting data to be sent to the printer 100 based on the user input. At step Sa3, the terminal device 300 sends the address of the terminal device 300 and the setting data as reservation data to the printer 100. The printer 100 performs reservation reception processing where it acquires the reservation data at step Sb1 and adds the reservation data to the end of the queue 212 at step Sb2.

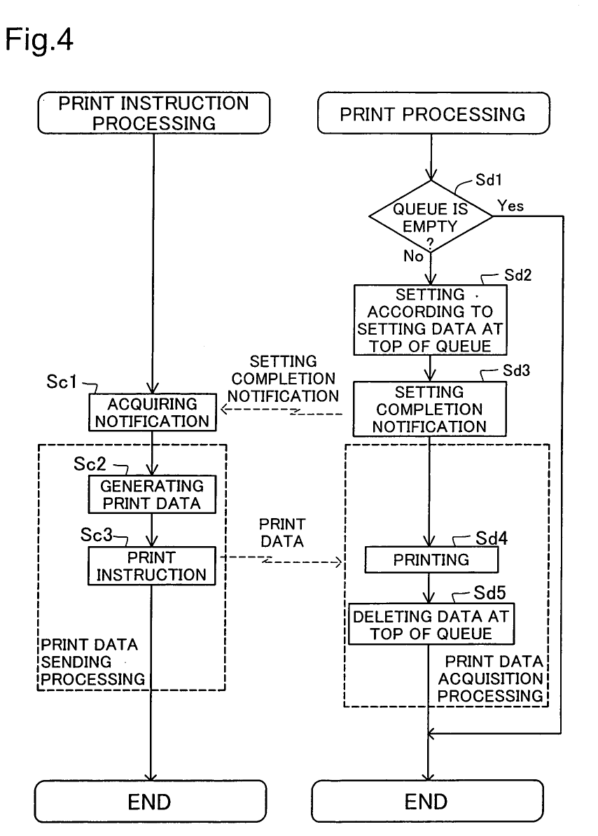

FIG. 4 is a flowchart of print processing. The left portion of FIG. 4 shows the processing performed by the terminal device 300, and the right portion shows the processing performed by the printer 100. The printing system 1000 may repeat the print processing. At step Sd1, the printer 100 checks whether or not the queue 212 is empty. If the queue 212 is empty, the printer 100 exits this processing without performing any further step.

At step Sd2, the printer 100 sets the printing conditions based on the setting data stored at the top of the queue 212. Then, at step Sd3, the printer 100 sends the setting completion notification to the terminal device 300. When the terminal device 300 receives the setting completion notification at step Sc1, it acquires document data to be printed from the application 330 at step Sc2, and then generates print data to be output to the printer 100.

The terminal device 300 sends the print data to the printer 100 at step Sc3, and then the printer 100 receives the print data to perform the printing at step Sd4. The printing is performed under the printing conditions set at step Sd2. After the completion of the printing, the printer 100 deletes the setting data and address stored at the top of the queue 212 at step Sd5.

The panel control module 230 of the printer 100 may perform the reservation processing (left portion of FIG. 2) and the print instruction processing (left portion of FIG. 3) as the setting control module 310 of the terminal device 300. However, the panel control module 230 informs the user of the printer 100 about the completion of the setting at step Sc2 of FIG. 4. In addition, the setting control module 310 does not send the print data at step Sc3.

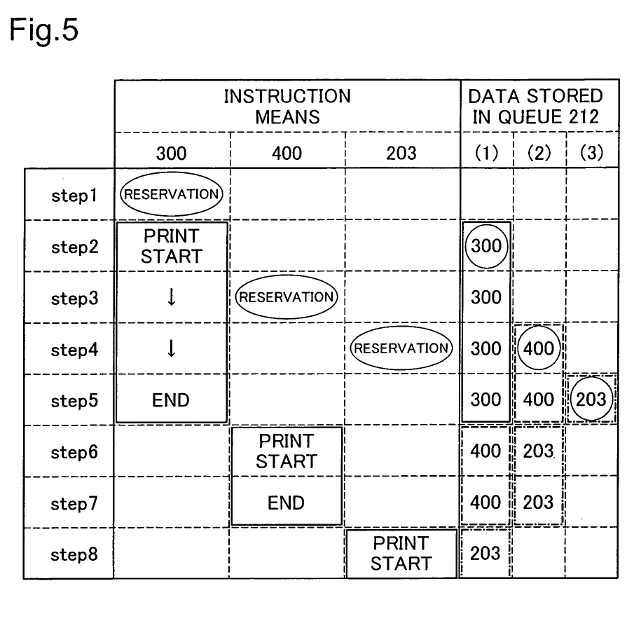

FIG. 5 is a schematic diagram illustrating an example of reservation and print processing in the printing system 1000. Hereinafter, the terminal devices 300 and 400, and setting panel 203 are generically referred to as instruction module for convenience of explanation. In addition, the setting data corresponding to these instruction module are referred to as setting data 300d, 400d, and 203d, respectively, and the addresses are referred to as addresses 300a, 400a, and 203a, respectively. FIG. 5 illustrates the operations relating to each instruction module and the contents of the queue 212 in the time series of steps 1 through 8. For convenience of explanation, the contents of the queue 212 are identified by codes (1), (2), and (3) in the order from the top to the end of the queue 212.

At step 1, the queue 212 is empty, and the instruction module 300 sends the address 300a and setting data 300d to the printer 100 to reserve the printing (step Sa3 of FIG. 3). The printer 100 adds the address 300a and setting data 300d to the queue 212 (step Sb2 of FIG. 3). At step 2, the setting data 300d and address 300a are stored on the location (1) at the top of the queue 212, and therefore the printer 100 sets the printing conditions and then prints according to the setting data 300d (steps Sd2 through Sd4 of FIG. 4).

During this printing, the instruction module 400 makes a reservation at step 3. In parallel to the printing, the printer 100 initiates the reservation reception processing (right portion of FIG. 3) to receive the reservation from the instruction module 400. Specifically, the printer 100 adds the address 400a and setting data 400d of the instruction module 400 to the location (2) of the queue 212. If the instruction module 203 also makes a reservation at step 4, the printer 100 adds the address 203a and setting data 203d of the instruction module 203 onto the location (3) of the queue 212.

At step 5, the printing through the instruction module 300 is completed. The printer 100 deletes the data on the location (1) at the top of the queue 212, that is, the setting data 300d and address 300a corresponding to the instruction module 300 (step Sd5 of FIG. 4). This brings forward the location of each data stored in the queue 212, which results in the setting data 400d and address 400a stored on the location (1) at the top. At step 6, the printer 100 sets the printing conditions and then prints based on the setting data 400d (steps Sd2 through Sd4 of FIG. 4). When the printing is completed at step 7, the printer 100 deletes the setting data 400d and address 400a from the queue 212. Next, at step 8, the printer 100 initiates the processing for the setting data 203d.

In the printing system 1000 described above, each of the instruction module cannot set the printing conditions for the printer 100 (at steps 2 through 5, 6 through 7, and 8 of FIG. 5, respectively) unless it makes a reservation in advance (at step 1, 3, and 4, respectively). Therefore, such a reservation is used to control the timing of setting operation for each instruction module, and thereby avoiding conflict among the setting operations. In addition, the user of each instruction module is assured of using the printer 100 through the reservation, and thereby increasing equity among the users of the printer 100. Furthermore, the setting operation for each instruction module is performed in the order of the reservation, and thereby avoiding inequity among the instruction module such as the setting operation being postponed unfairly for the instruction module that made a reservation earlier.

In this embodiment, the printer 100 informs about the completion of the setting (step Sd3 of FIG. 4). This enables each instruction module to immediately perform the printing. In addition, the operating rate of the printer 100 is improved. In this embodiment, each instruction module sends the setting data along with the address (step Sc4 of FIG. 4). Therefore, once the user of each instruction module causes the instruction module to make a reservation, he or she need not make any additional operation for setting, and thereby reducing the user's labor of operation.

In the printing system 1000, the above-mentioned IP address may be replaced by a user ID of the user who uses the printer 100 or may be replaced by integrated data of IP address and user ID. In the embodiment, the printer 100 realizes the settings sent from each instruction module in the order of the reservation, but may realize in another order. For example, it may realize the settings sent from each instruction module according to predetermined priorities among the users who use the printer 100 or among the instruction module that send the setting data to the printer 100. Alternatively, it may realize the settings in the order corresponding to the sizes of print data.

B. Second Embodiment

B1. Configuration

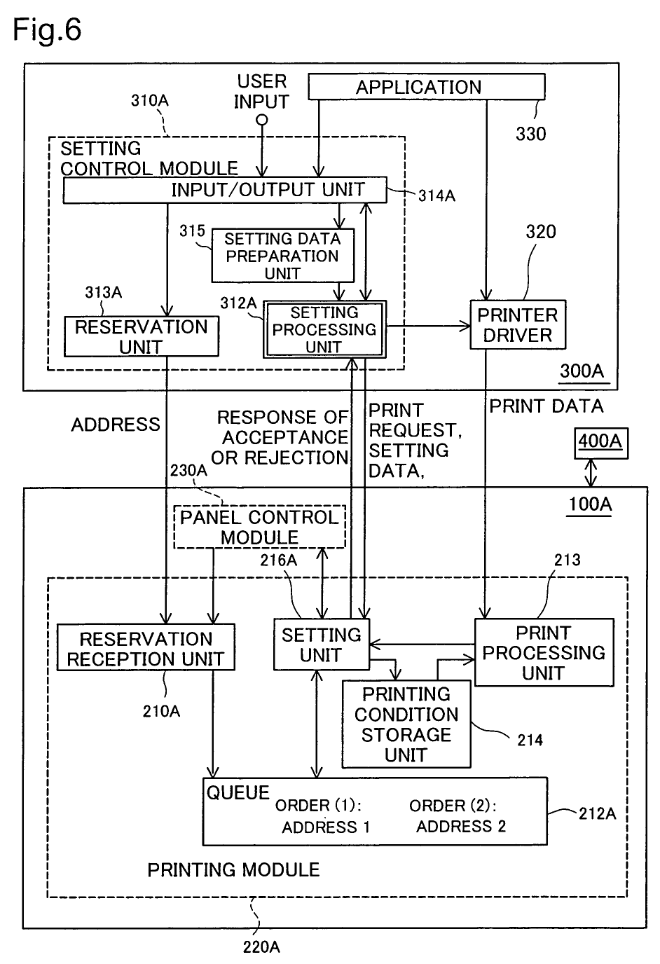

FIG. 6 is a schematic diagram illustrating the configuration of function blocks implemented in a terminal device 300A and a printer 100A according to a second embodiment. The printing system according to the second embodiment, which is essentially the same as that according to the first embodiment, includes the printer 100A and two terminal devices 300A and 400A. The following description is made mainly for the terminal device 300A, but the terminal device 400A also has the same functions and performs the same processing as the terminal device 300A. The address and setting data are sent to the printer 100 during the reservation processing in the first embodiment, but only the address is used as data for reservation in the second embodiment.

A reservation unit 313A of the terminal device 300A sends the address as data for reservation to the printer 100A. The terminal device 300A includes a setting processing unit 312A instead of the information reception unit 312 of the first embodiment. The reservation unit 313A makes a reservation, and then the setting processing unit 312A sends a print request to the printer 100A. Once the printer 100 receives the print request, a setting unit 216A determines based on a predetermined condition whether or not the printing through the terminal device 300A is permitted, and then sends the determination result to the terminal device 300A. If the printing is permitted, the setting processing unit 312A sends the setting data to the printer 100A to set the printing conditions. After sending the setting data, the setting processing unit 312A informs the printer driver 320 that the printing conditions have been set.

In the printer 100A, a reservation reception unit 210A acquires the address from the terminal device 300A, and then stores it in a queue 212A. The setting unit 216A receives the print request from the terminal device 300A. The setting unit 216A permits the printing if the address of the terminal device 300A is identical to the address stored at the top of the queue 212A, and otherwise rejects the print request. If the setting unit 216A permits the printing, it acquires the setting data from the terminal device 300A to set the printing conditions. After the completion of the printing of the terminal device 300A, the setting unit 216A deletes the address of the terminal device 300A stored at the top of the queue 212A.

B2. Processing

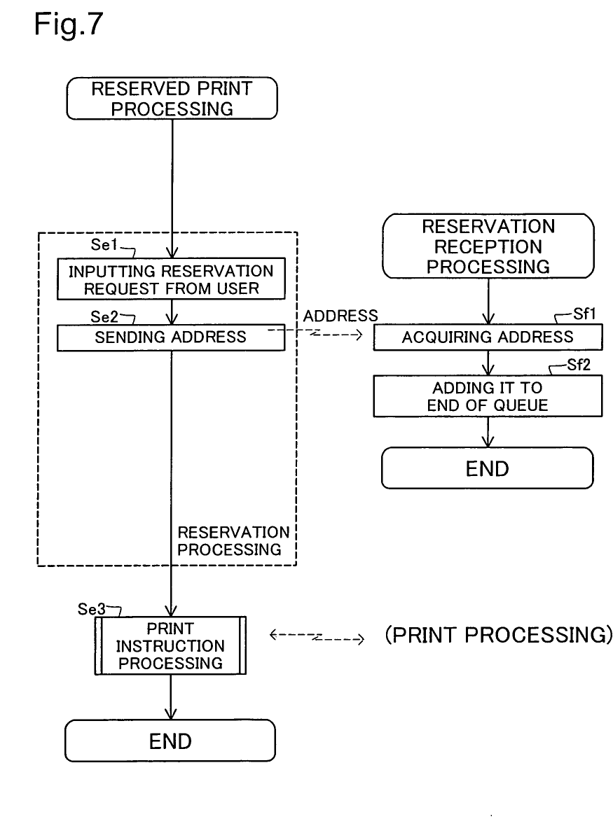

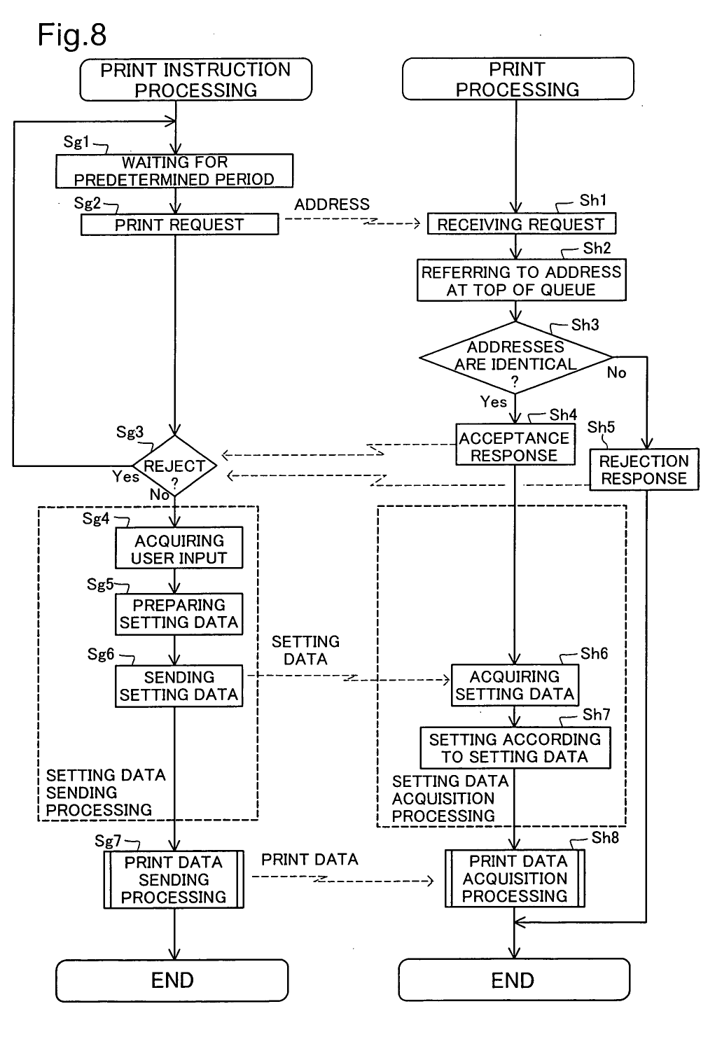

FIG. 7 is a flowchart of reservation processing according to the second embodiment. The left portion of FIG. 7 shows the processing performed by the terminal device 300A, and the right portion shows the processing performed by the printer 100A. The terminal device 300A initiates reserved print processing shown on the left portion of FIG. 7 in response to the user's command for print request. The terminal device 300A inputs the user's command at step Se1, and then sends the address of the terminal device 300A to the printer 100A. The printer 100A acquires the address at step Sf1, and then adds it to the queue 212A at step Sf2. After the reservation processing (steps Se1 through Se2), the terminal device 300A performs print instruction processing at step Se3, which will be described further with reference to FIG. 8.

FIG. 8 is a flowchart of print processing according to the second embodiment. The left portion of FIG. 8 shows the processing performed by the terminal device 300A at step Se3 of FIG. 7, and the right portion shows the processing performed by the printer 100A.

At step Sg1, the terminal device 300A waits for a lapse of predetermined period, and then sends the print request to the printer 100A. In response to this request, the printer 100A initiates the print processing shown on the right portion of FIG. 8. The printer 100A receives the print request from the terminal device 300A at step Sh1, and then refers to the address stored at the top of the queue 212A at step Sh2. The printer 100A determines whether or not the address stored at the top of the queue 212A is identical to the address acquired from the terminal device 300A at step Sh3. If they are identical, the printer 100A sends the response to the terminal device 300A to accept the print request at step Sh4. Otherwise, the printer 100A sends the response to the terminal device 300A to reject the print request at step Sh5, and then exits the print processing.

The terminal device 300A receives the response at step Sg3. If the print request is rejected, the terminal device 300A returns back to step Sg1 to wait for a lapse of the predetermined period, and then sends the print request again at step Sg2. If the print request is accepted, the terminal device 300A prepares the setting data according to the user input at steps Sg4 and Sg5, and then sends it to the printer 100A (step Sg6). The printer 100A acquires the setting data from the terminal device 300A at step Sh6 to set the printing conditions at step Sh7. Then, the terminal device 300A and the printer 100A perform the print data sending processing (steps Sc2 through Sc3 of FIG. 4) at step Sg7 and the print data acquisition processing (steps Sd4 through Sd5 of FIG. 4) at step Sh8, respectively. However, the queue 212A stores therein only the address, and therefore the printer 100A deletes only the address at step corresponding to step Sd5 of FIG. 4.

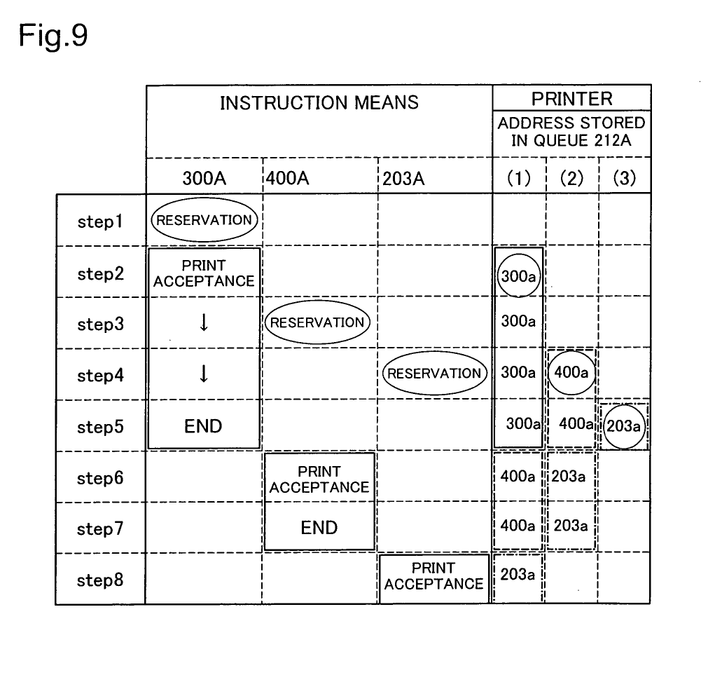

FIG. 9 is a schematic diagram illustrating an example of processing according to the second embodiment. Here, instruction module consisting of a panel control module 230A and the setting panel 203 is referred to as instruction module 203A. As in the first embodiment, the addresses and the setting data corresponding to instruction module 300A, 400A, and 203A are referred to as addresses 300a, 400a, and 203a, and as setting data 300d, 400d, and 203d, respectively. The following description is based on the assumption that the queue 212A is empty at step 1.

At step 1, the queue 212A is empty, and the instruction module 300A sends the address 300a to the printer 100A to make a reservation (step Se2 of FIG. 7). The printer 100A adds the address 300a to the queue 212A. The instruction module 300A, which made a reservation, sends the print request at step 2. In response to this request, the printer 100A initiates the print processing (shown on the right portion of FIG. 8). At step 2, the address 300a is stored on the location (1) at the top of the queue 212A, and therefore the printer 100A accepts the print request from the instruction module 300A. After step 2, the instruction module 300A causes the printer 100A to set the printing conditions and print (steps Sg4 through Sg6 and steps Sh6 and Sh7 of FIG. 8).

If the instruction module 400A makes a reservation at step 3 during this printing, the printer 100A initiates the reservation reception processing (right portion of FIG. 7) to receive the reservation from the instruction module 400A, in parallel to the printing according to the instruction from the instruction module 300A. In this processing, the printer 100A adds the address 400a onto the location (2) of the queue 212A. If the instruction module 203A also makes a reservation at step 4, the printer 100A adds the address 203a of the instruction module 203A onto the location (3) of the queue 212A.

The instruction module 400A and 203A repeat the print request after the reservation made at steps 3 and 4, respectively (see steps Sg1 through Sg3 of FIG. 8). However, the address 300a of the instruction module 300A is stored on the location (1) at the top of the queue 212A by the time point of step 5. Therefore, even if the instruction module 400A or 203A sends the print request before step 5, the printer 100A rejects the print request (see steps Sh2, Sh3, and Sh5 of FIG. 8). Even if the instruction module 400A and 203A sends the print request before steps 3 and 4, respectively, the printer 100A may reject the print request based on the content stored on the location (1) at the top of the queue 212A.

The printing through the instruction module 300A is completed at step 5, and then the printer 100A deletes the data stored on the location (1) at the top of the queue 212A, that is, the address 300a of the instruction module 300A (step Sh8 of FIG. 8 or step Sd5 of FIG. 4). This causes the address 400a to be stored on the location (1) at the top of the queue 212A. Consequently, if the instruction module 400A sends the print request at step 6, the printer 100A accepts the print request. The instruction module 203A repeats the print request even after step 5. However, even after step 5, the address 400a of the instruction module 400A remains stored on the location (1) at the top of the queue 212A until step 7. Consequently, if the instruction module 203A sends 21. the print request before step 7, the printer 100A rejects the print request.

The printing through the instruction module 400A is completed at step 7, and then the address 203a of the instruction module 203A is stored at the top of the queue 212A. Consequently, if the instruction module 203A sends the print request at step 8, the printer 100A accepts the print request. If the instruction module 300A and 400A sends the print request after steps 5 and 7, respectively, the printer 100A may reject the print request based on the content stored on the location (1) at the top of the queue 212A.

The printing system described above ensures equity among the users of the respective instruction module, and avoids conflict among the setting operations. Furthermore, the printing system avoids inequality among the users such as the setting operation being postponed unfairly for the user who made a reservation earlier.

The printer 100A according to this embodiment need not store any setting data in the queue 212A. This enables the structure of the queue 212A to be simplified.

C. Third Embodiment

C1. Configuration

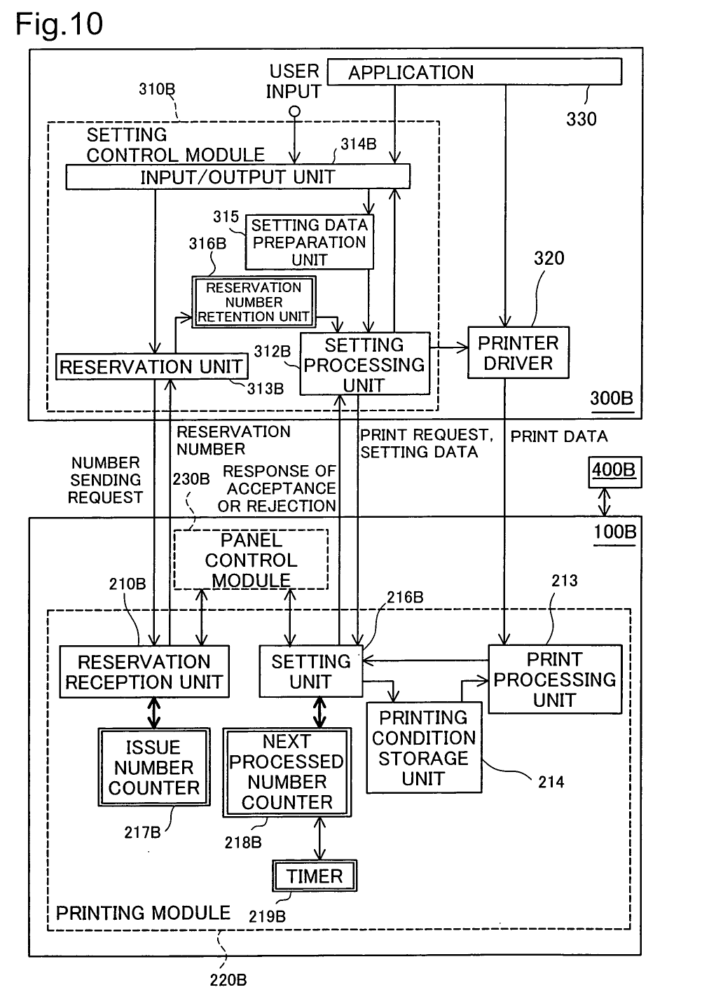

FIG. 10 is a schematic diagram illustrating the configuration of function blocks implemented in each device according to a third embodiment. The printing system according to the third embodiment, which is essentially the same as that according to the second embodiment, includes the printer 100B and two terminal devices 300B and 400B. The following description is made mainly for the terminal device 300B, but the terminal device 400B also has the same functions and performs the same processing as the terminal device 300B. Although the terminal device sends the address etc. to the printer in order to make a reservation in the first and second embodiments, the terminal device acquires a predetermined reservation number from the printer 100B in order to make a reservation in the third embodiment.

The printer 100B includes an issue number counter 217B and next processed number counter 218B to store reservation numbers. The reservation number represents data indicating the order in which each instruction module causes the printer 100B to print. A so-called electronic signature is attached to the reservation number, and therefore the printer 100B, terminal device 300B, and the like may determine based on the electronic signature whether or not the reservation number has been falsified. When the printer 100B starts, the reservation numbers in the two counters are automatically set to the same value (1). Hereinafter, the reservation numbers stored in the issue number counter 217B and next processed number counter 218B may be referred to as issue number and next processed number, respectively.

A reservation reception unit 210B sends the reservation number stored in the issue number counter 217B to the terminal device 300B in response to a number sending request from the terminal device 300B. After the sending of reservation number, the reservation reception unit 210B increments the reservation number stored in the issue number counter 217B by 1. A setting unit 216B receives the reservation number from the terminal device 300B in order to receive the print request. The setting unit 216B determines whether or not the reservation number acquired from the terminal device 300B is identical to the next processed number stored in the next processed number counter 218B. The setting unit 216B accepts the print number if the two numbers are identical, but rejects if they are not identical or if the reservation number has been falsified. The setting unit 216B informs the terminal device 300B about the acceptance or rejection of the print request as in the second embodiment. When the terminal device 300B completes the printing, the setting unit 216B increments the reservation number stored in the next processed number counter 218B. A timer 219B will be described in one modification.

In the terminal device 300B, a reservation unit 313B requests the sending of number to acquire the reservation number from the printer 100B, and then retains it in a reservation number retention unit 316B. A setting processing unit 312B sends the retained reservation number to the printer 100B for print request.

C2. Processing

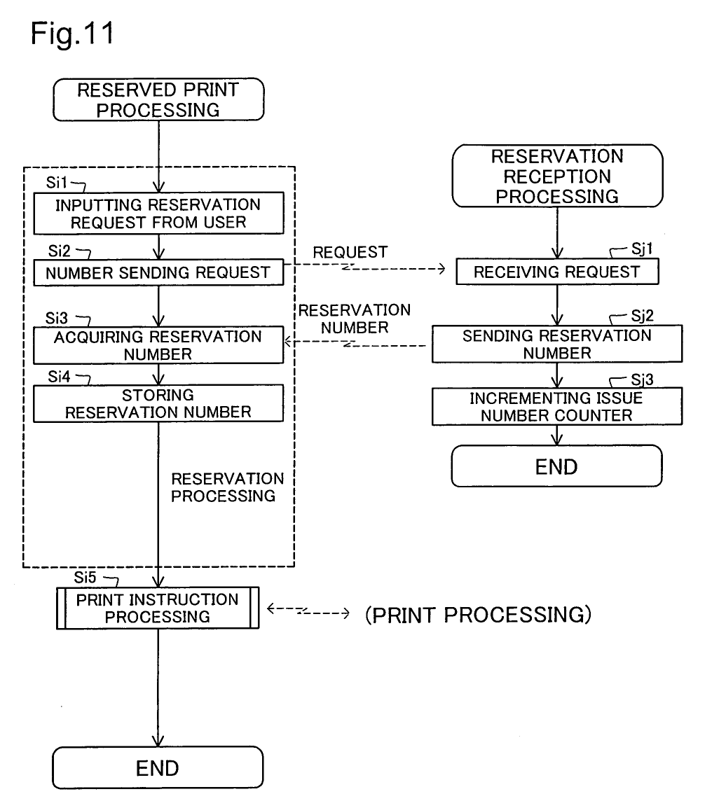

FIG. 11 is a flow chart of the reservation processing in the third embodiment. The left portion of FIG. 11 shows the processing performed by the terminal device 300B, and the right portion shows the processing performed by the printer 100B. The terminal device 300B initiates reserved print processing shown on the left portion of FIG. 7 in response to the user's command for print request. The terminal device 300B inputs the command at step Si1, and then sends the number sending request to the printer 100A in order to request sending of reservation number at step Si2. The printer 100B receives the request at step Si1, and then sends the reservation number stored in the issue number counter 217B to the terminal device 300B at step Sj2. After the sending, the printer 100B increments the issue number counter 217B. The terminal device 300B acquires the reservation number from the printer 100B at step Si3, and then retains it in the reservation number retention unit 316B at step Si4.

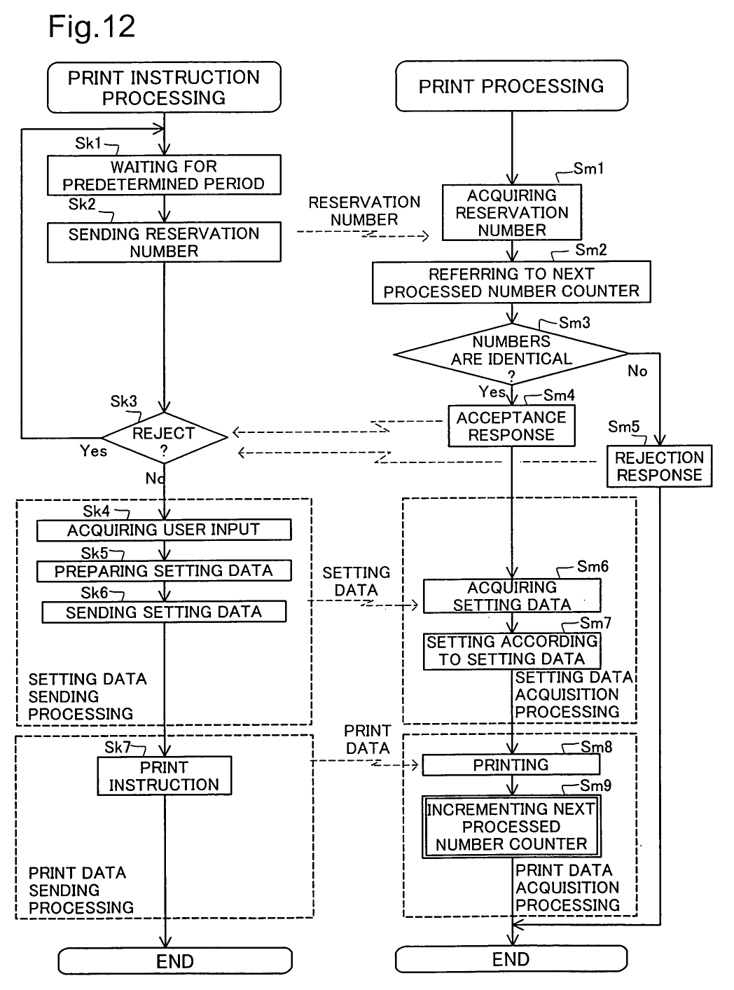

FIG. 12 is a flowchart of print processing according to the third embodiment. The left portion of FIG. 12 shows the processing performed by the terminal device 300B at step Si5 of FIG. 11, and the right portion shows the processing performed by the printer 100B.

The terminal device 300B sends the reservation number to request the printing at step Sk2, and the printer 100B acquires the reservation number to receive the print request at step Sm1. Once the printer 100B receives the print request, it refers to the reservation number stored in the next processed number counter 218B at step Sm2, and then determines the acceptance or rejection of the print request at step Sm3. The printer 100B accepts the print request only if the reservation number acquired from the terminal device 300B is identical to the reservation number stored in the next processed number counter 218B and has the electronic signature.

The printer 100B makes a response about the acceptance or rejection of the print request to the terminal device 100B. If the printer 100B makes a rejection response at step Sm5, then it exits the processing. If the terminal device 300B receives the rejection response at step Sk3, then it returns back to step Sk1. If the terminal device 100B receives the acceptance response (step Sm4) from the printer 100B at step Sk3, then it acquires the user input at step Sk4, prepares the setting data according to the user input at step Sk5, sends the prepared setting data at step Sk6, and sends the print data at step Sk7. After the acceptance response, the printer 100B acquires the setting data at step Sm6, configures the settings according to the setting data at step Sm7, and then performs the printing at step Sm8. After the printing, the printer 100B increments the next processed number counter 218B at step Sm9.

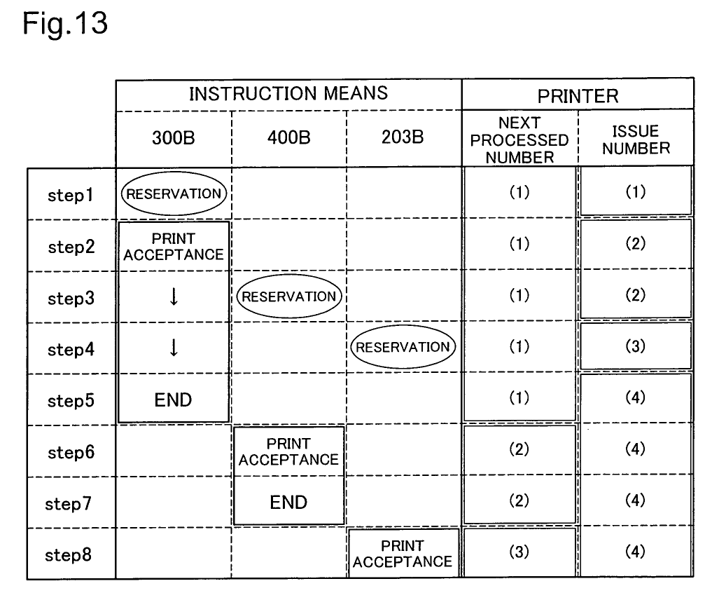

FIG. 13 is a schematic diagram illustrating an example of processing according to the third embodiment. Here, instruction module consisting of a panel control module 230B and the setting panel 203 is referred to as instruction module 203B. As in the embodiments described above, the addresses and the setting data corresponding to instruction module 300B, 400B, and 203B are referred to as addresses 300a, 400a, and 203a, and as setting data 300d, 400d, and 203d, respectively. For convenience of explanation, the reservation numbers are identified by (1), (2), and (3). FIG. 13 illustrates the operations relating to each instruction module and the values of next processed number and issue number in the time series of steps 1 through 8.

At step 1, the two counters of the printer 100B have the same reservation number (1), and the terminal device 300B sends the number sending request to the printer 100B (step Si2 of FIG. 11). In response to this request, the printer 100B sends the reservation number (1) stored in the issue number counter 217B to the terminal device 300B (step Sj2 of FIG. 11), and then increments the reservation number stored in the issue number counter 217B into (2) (step Sj3 of FIG. 11). At step 2, the terminal instruction module 300B uses the reservation number (1) acquired at step 1 to send the print request (step Sk2 of FIG. 12). At step 2, the reservation number (1) is stored in the next processed number counter 218B, and therefore the printer 100B accepts the print request from the instruction module 300B. After step 2, the instruction module 300B causes the printer 100B to set the printing conditions and print (step Sk4 and following steps, and step Sm6 and following steps of FIG. 12).

When the instruction module 400B makes a reservation at step 3 during this printing, the printer 100B initiates the reservation reception processing (right portion of FIG. 12) to receive the reservation from the instruction module 400B, in parallel to the printing. In this processing, the printer 100B sends the reservation number (2) to the instruction module 300B, and then increments the reservation number stored in the issue number counter 217B into (3). If the instruction module 203B also makes a reservation at step 4, then the printer 100B sends the reservation number (3) to the instruction module 203B.

The instruction module 400B and 203B repeat the print request after acquiring the reservation numbers (2) and (3) at steps 3 and 4, respectively (see steps Sk1 through Sk3 of FIG. 12). However, the reservation number counter 217B stores therein the reservation number (1) until step 5. Therefore, even if the instruction module 400B or 203B sends the print request before step 5, the printer 100B rejects the print request (see steps Sk2, Sk3, and Sk5 of FIG. 12). Even if the instruction module 400B and 203B send the print request without sending the reservation number before steps 3 and 4, respectively, the printer 100B may reject the print request (see step Sm3 of FIG. 12).

When the printing through the instruction module 300B is completed at step 5, the printer 100B increments the next processed number counter 218B into (2) (step Sm9 of FIG. 12). If the instruction module 400B uses the reservation number (2) acquired at step 3 to send the print request at step 6, then the printer 100B accepts the print request since the reservation number acquired from the terminal device 400B and the next processed number are equal to (2). The instruction module 203B repeats the print request even after step 5. However, even after step 5, the reservation number remains equal to (2) until step 7. Consequently, even if the instruction module 203B sends the print request before step 7, the printer 100B rejects the print request.

The printing through the instruction module 400B is completed at step 7, and then the next processed number is incremented into (3). Consequently, if the instruction module 203B sends the print request at step 8, then the printer 100B accepts the print request. If the instruction module 300B and 400B send the print request after steps 5 and 7, respectively, the printer 100A may reject the print request based on the content stored in the next processed number counter 218B.

The printing system described above ensures equity among the users of the respective instruction module, and avoids conflict among the setting operations. Furthermore, the printing system avoids inequity among the users such as the setting operation being postponed unfairly for the user who made a reservation earlier.

The printer 100B according to this embodiment need not perform complex management on the setting data and address acquired from each instruction module. For example, it need not perform the complex management using the queue. This enables the structure of the printer 100B to be simplified.

Each instruction module may use the reservation number transferred from another instruction module to send the print request to the printer 100B. Instead of using the reservation number alone, authorization data may be used that contains the reservation number, and the address of the instruction module that may use the reservation number for print request. The printer 100B may accept the print request only if the address of the instruction module that sent the authorization data for print request is identical to the address contained in the authorization data.

D. Modifications

There are shown two modifications of the third embodiment.

D1. Time Limit for Setting

In this modification, the setting unit 216B of the printer 100B sends change notification of next processed number for each increment of the next processed number counter 218B (step Sm9 of FIG. 12). The change notification of next processed number is achieved by sending the next processed number incremented to all computers connected to the network NT and the panel control module 230B. Acquiring the change notification of next processed number enables each instruction module to know whether or not the reservation number retained in its own reservation number retention unit 316B is identical to the next processed number.

In the functional blocks of the printer 100B shown in FIG. 10, the timer 219B measures elapsed time. The timer 219B clears the measured time to zero for each increment of the next processed number counter 218B (step Sm9 of FIG. 9), and increments the next processed number counter 218B when it detects a lapse of predetermined period after the time point of the clearance. The timer 219B also clears the measured time to zero at the time of increment performed by the timer 219B. The setting unit 216B also sends the above-mentioned change notification of next processed number when the timer 219B increments the next processed number counter 218B.

If the timer 219B increments the next processed number retention unit 217a, the printer 100B rejects a future print request using the reservation number before the increment. Consequently, the instruction module that has the reservation number before the increment cannot perform the setting operation unless sending the printing request by the time the timer 219B detects a lapse of the predetermined period after the sending of the change notification of next processed number. In this manner, the timer 219B sets time limit for setting operation of the terminal device 300B.

At step Sk1 of FIG. 12, the terminal device 300B waits until the reservation number retained in the reservation number retention unit 316B becomes identical to the next processed number. In this modification, the determination process at step Sk3 may be skipped since the terminal device 300B sends the print request (step Sk2 of FIG. 12) after the reservation number has become identical to the next processed number.

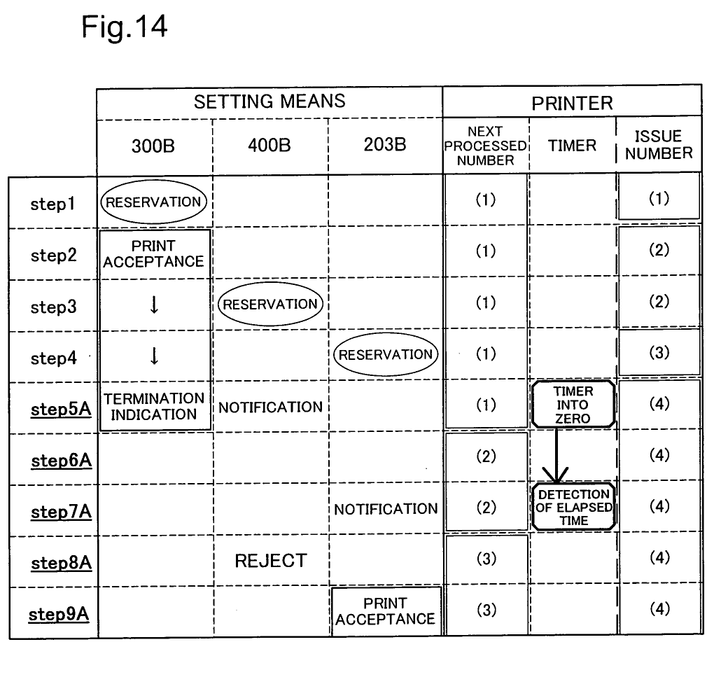

FIG. 14 is a schematic diagram illustrating an example of processing in the case where the time limit is set for print request. Steps 1 through 4 of FIG. 14 are identical to those of FIG. 13. When the printing through the instruction module 300B is completed at step 5A of FIG. 14, the printer 100B clears the time measured by the timer 219B to zero, and sends the reservation number (2) for change notification of next processed number. Step 6A exemplifies a certain time point when the timer 219B measures elapsed time.

At step 7A after the above predetermined period from step 5A, the printer 100B increments the next processed number counter 218B into (3), and then sends the incremented reservation number (3) for change notification of next processed number. If the instruction module 400B sends the print request using the reservation number (2) in disregard of this notification at step 8A, and then the printer 100B rejects the print request from the instruction module 400B because of the next processed number (3). At step Sk1 of FIG. 12, each instruction module may return back to step Si2 (FIG. 11) to make a reservation again if the next processed number acquired through the change notification of next processed number is greater than the reservation number retained in the reservation number retention unit 316B. Next, if the instruction module 203B sends the print request using the reservation number (3) at step 9A, the printer 100B accepts the print request since the next processed number is also equal to (3).

The printing system 1000 described above invalidates the reservation number of the instruction module that has not performed the setting operation for a long time, and thereby improving equity among the instruction module.

In the above description, the timer 219B detects a lapse of the predetermined period after the next processed number counter 218B is incremented, but another method is also applicable. The timer 219B may detect a lapse of predetermined period after the reservation for each instruction module that has made the reservation, and increment the next processed number counter 218B according to each detection result.

A method of providing time limit for setting is not limited to the above-mentioned method. For example, reservation time information may be used instead of the reservation number in order to provide the time limit. By way of example, at step 1, 3, and 4 of FIG. 9, the printer 100B provides the instruction module 300B, 400B, and 203B with the reservation time information representing time period “10:00-10:05”, “10:05-10:10”, and 10:10-10:15”, respectively. The setting unit 216B may compare the reservation time information input from the instruction module with current time to determine the acceptance or rejection of the print request.

The techniques described above are applicable to the printer according to the first or second embodiment. In such a case, the timer 219B may delete the address stored at the top of the queue 212 (or queue 212A) instead of incrementing the next processed number counter 218B.

D2. Consideration of Reservation Count

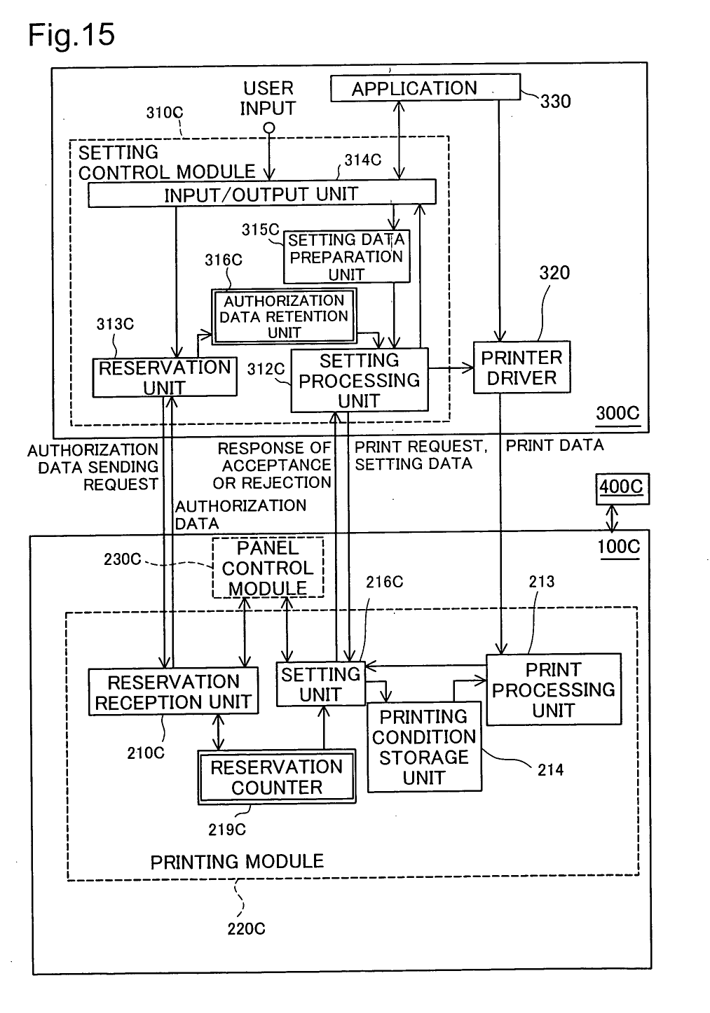

FIG. 15 is a schematic diagram illustrating the configuration of function blocks implemented in each device in a printing system taking into consideration the reservation count. The printing system according to the modification shown in FIG. 15, which is essentially the same as that according to the third embodiment, includes the printer 100C and two terminal devices 300C and 400C. The following description is made mainly for the terminal device 300C, but the terminal device 400C also has the same functions and performs the same processing as the terminal device 300C. In the modification of FIG. 15, a predetermined authorization data is used instead of the reservation number in the third embodiment. It may be determined based on the electronic signature attached to the authorization data whether or not the authorization data has been falsified. However, the authorization data is not ordered unlike the reservation number.

In the terminal device 300C, a reservation unit 313C requests the sending of authorization data to acquire the authorization data from the printer 100C, and then retains it in an authorization data retention unit 313C. A setting processing unit 312C sends the authorization data to the printer 100C for print request.

A reservation acceptance unit 210C of the printer 100C sends the authorization data to the terminal device 300C in response to the sending request of authorization data. A setting unit 216C receives the authorization data from the terminal device 300C, and then accepts the print request of the terminal device 300C if the authorization data has not been falsified (steps Sm4, Sm6, and the following steps of FIG. 12). A reservation counter 219C stores therein a difference between the number of instruction module whose reservation has been received and the number of instruction module whose printing has been completed, which is hereinafter referred to as reservation count. The reservation count stored is automatically set to zero when the printer 100C starts. The reservation reception unit 210C increments the reservation counter 217C for each reception of reservation, and the setting unit 216C decrements the reservation counter 217C for each completion of printing. The reservation reception unit 210C receives a new reservation and then sends authorization data only if the reservation count is not greater than a predetermined number. The predetermined number is equal to 2 in the following description.

The printer 100C performs the reservation reception processing shown on the right portion of FIG. 11 only if the reservation count is less than the predetermined number. The printer 100C sends the authorization data instead of the reservation number at step Sj2 of FIG. 11. Then, the printer 100C increments the reservation counter 219C instead of the issue number counter 217B at step Sj3. The terminal device 300C acquires the authorization data at step Si3, and then retains it in the authorization data retention unit 316C. At step Sk2 of FIG. 12, the terminal device 300C sends the retained authorization data to the printer 100C. The printer 100C checks whether or not the authorization data received from the terminal device 300C has been falsified (steps Sm2 through Sm3 of FIG. 12), and then accepts the print request if it is not falsified (steps Sm4, Sm6, and the following steps of FIG. 12). After the terminal device 300C completes the printing, the printer 100C increments the reservation counter 217C instead of the next processed number counter Sm9 at step Sm9 of FIG. 11.

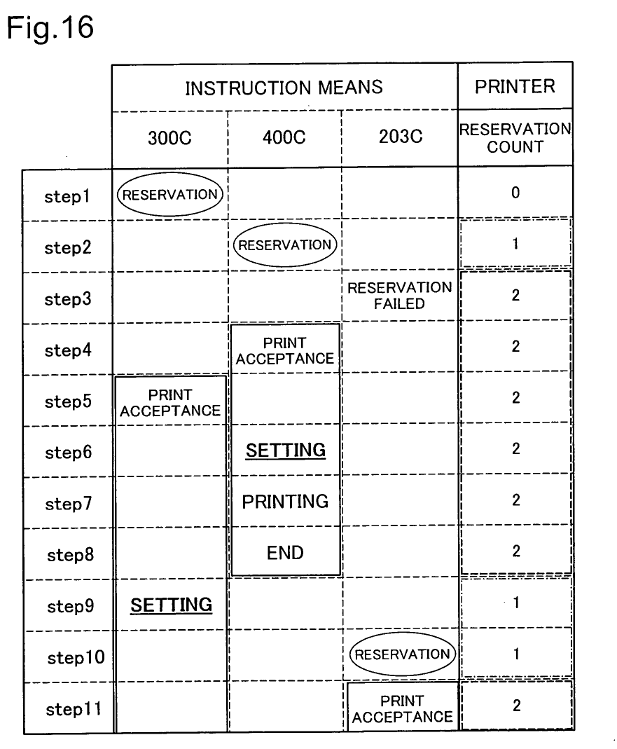

FIG. 16 is a schematic diagram illustrating an example of reservation and print processing in the printing system taking into consideration the reservation count. Here, instruction module consisting of a panel control module 230C and the setting panel 203 is referred to as instruction module 203C for convenience of explanation. As in the embodiments described above, the addresses and the setting data corresponding to instruction module 300C, 400C, and 203C are referred to as addresses 300a, 400a, and 203a, and as setting data 300d, 400d, and 203d, respectively. At step 1, the reservation counter 219C stores therein the reservation count 0.

At steps 1 and 2, the instruction module 300C and 400C respectively request the sending of authorization data to reserve the printer 100C. In response to these requests, the printer 100C sends the authorization data and increments the reservation counter 219C at steps 1 and 2. Consequently, the reservation counter 219C stores therein the reservation count 2 just after step 2. At step 3, even if the instruction module 203C tries to reserve, the printer 100C rejects the reservation because of the reservation 2. Therefore, the instruction module 203C cannot acquire the authorization data at step 3. At steps 4 and 5, if the instruction module 400C and 300C respectively send the print request using the authorization data acquired at steps 2 and 1, the printer 100C accepts the print requests.

The instruction module 400C sets the printing conditions for the printer 100C at step 6 (steps Sk6, and Sm6 through Sm7), and then the printer 100C prints under the printing conditions at step 7 (steps Sk7, Sm8 through Sm9), and decrements the reservation counter 219C into 1 at step 8 where the printing through the instruction module 400C is completed. The instruction module 300C sets the printing conditions for the printer 100C at step 8. If the instruction module 203C tries to reserve at step 10, the printer 100C accepts the reservation because of the reservation count 1, and then sends the authorization data to the instruction mean 203C. The instruction module 203C sends the print request using the authorization data at step 11.

The printer 100C rejects the print request from the instruction module 203C before step 10. This ensures equity among the users of the respective instruction module, and avoids conflict among the setting operations.

In addition, the printer 100C rejects the reservation by the instruction module 203C at step 3, and thereby avoiding the setting operation through the instruction module 203C during steps 3 through 8. This reduces the possibility of conflict.

At least part of authorization data may indicate the time limit of setting operation. For example, it may indicate the time limit such as “10:00.” The printing module 220 accepts the print request only if it acquires the authorization data that is not past its time limit.

In the modification of FIGS. 15 and 16, the reservation number may be used instead of the authorization data. For example, at step 5 of FIG. 16, the printer 100C may compare the reservation number that the instruction module 300C sent for print request with the reservation number that the instruction module 400C sent at step 3. The printer 100C may determine based on this comparison result whether it accepts or rejects the print request from the instruction module 400C.

In the first or second embodiment, the order of reservation may be left out of consideration as in the modification of FIGS. 15 and 16. In such a case, a storage unit that stores therein the addresses etc. with disregard to the reservation order is provided instead of the queue 212 or 212A of the printer 100 or 100A. The printer 100 of the first embodiment selects one of the setting data stored in the storage unit to perform the setting operation according to the selected setting data. The printer 100A of the second embodiment accepts the print request if the address of the instruction module that requests the printing is identical to one of the addresses stored in the storage unit.

In the first or second embodiment, the reservation count may be taken into consideration as in the above modification. For example, the printer 100A of the second embodiment may reject a new reservation if the number of addresses stored in the queue 212A is equal to or more than a predetermined number. Alternatively, the printer 212A may identify the reservation count by using a pointer that identifies the address stored at the end of the queue 212A, and may control the reception of new reservation according to the identified reservation count. This is also applicable to the printer 100 of the first embodiment.

Hereinabove, the printing systems according to the present invention have been described with reference to the embodiments. However, the above embodiments of the present invention are intended to facilitate a better understanding of the present invention and do not limit the present invention. The present invention may be modified and improved without departing from the spirit and the scope of claim for patent.

1. A printer that prints according to an instruction on setting of printing condition, the instruction being sent from instruction module, the printer comprising:
a reservation reception unit that receives identification information identifying the instruction module as a reservation for usage of the printer;
a storage unit that stores therein the received identification information;
a setting unit that acquires setting data and sets a printing condition for the printer according to the setting data, the setting data representing the content of setting given by the instruction module identified by the stored identification information; and
a printing unit that prints under the set printing condition.

2. A printer according to claim 1, wherein the reservation reception unit controls the reception so that the number of the received identification information for which the acquisition of setting data is not completed is not greater than a predetermined number.

3. A printer according to claim 1, wherein a predetermined validity period is set for the identification information, and
the printer further comprises an invalidating unit that deletes the identification information stored in the storage unit on expiration of the validity period.

4. A printer according to claim 1, wherein
the storage unit stores therein the identification information in association with a predetermined order of processing, and
the setting unit acquires the setting data according to the order of processing.

5. A printer according to claim 1, wherein
the reservation reception unit receives the setting data along with the identification information,
the storage unit stores therein the setting data in association with the identification information, and
the setting unit acquires the setting data from the storage unit.

6. A printer according to claim 1 further comprising:
an information unit that sends permission information indicating a permission of setting and printing to the instruction module having the permission.

7. A printer that prints according to an instruction on setting of printing condition, the instruction being sent from instruction module, the printer comprising:
an issue unit that sends predetermined authorization data necessary for reception of the instruction to the instruction module;
a setting unit that, only if receiving both setting data representing the content of the setting and the authorization data from the instruction module, performs the setting based on the acquired setting data; and
a printing unit that prints under the set printing condition.

8. A printer according to claim 7, wherein the issue unit controls the sending of authorization data so that the number of the sent authorization data for which the setting is unprocessed is not greater than a predetermined number.

9. A printer according to claim 7, wherein
a predetermined validity period is set for the authorization data, and
the setting unit performs the setting only if receiving the authorization data that is not past the validity period.

10. A printer according to claim 7, wherein
the authorization data is associated with a predetermined order of processing, and
the setting unit determines based on the order of processing whether or not the setting is permitted.

11. A printer according to claim 10 further comprising:
an information unit that specifies the authorization data to be processed subsequently, and informs the instruction module that the setting is permitted.

12. A printer according to claim 11, wherein the setting unit invalidates the authorization data at the time a predetermined period has elapsed after the information.

13. A setting device that sets a printing condition for the printer according to claim 1, the setting device comprising:
a reservation unit that sends the identification information to the printer to make the reservation; and
a sending unit that generates setting data representing the content of the setting according to an operation of a user, and sends the setting data to the printer.

14. A setting device that sets a printing condition for the printer according to claim 7, the setting device comprising:
an acquisition unit that acquires the authorization data from the printer; and
a sending unit that generates setting data representing the content of the setting according to an operation of a user, and sends the setting data and the authorization data to the printer.

15. A printing method comprising:
receiving identification information as a reservation for a usage of the printer, the identification information identifying instruction module for instructing the printer on setting of a printing condition;
storing the received identification information;
acquiring setting data representing the content of setting from the instruction module identified by the stored identification information, and setting a printing condition according to the setting data; and
printing under the set printing condition.

16. A printing method comprising:
sending predetermined authorization data to instruction module that instructs the printer on setting of a printing condition, the authorization data being necessary for reception of the instruction;
only if receiving both setting data representing the content of the setting and the authorization data from the instruction module, performing the setting based on the acquired setting data; and
printing under the set printing condition.

17. A setting method of setting a printing condition for a printer, the setting method comprising:
sending identification information to the printer to make a reservation, the identification information identifying instruction module for instructing the printer on setting of a printing condition; and
generating setting data representing the content of the setting according to an operation of a user, and sending the setting data to the printer.

18. A setting method of setting a printing condition for a printer, the setting method comprising:
acquiring predetermined authorization data from the printer, the authorization data being necessary for instructing the printer on setting of a printing condition; and
generating setting data representing the content of the setting according to an operation of a user, and sends the setting data and the authorization data to the printer.
